(19) United States
(12) Patent Application Publication
(10) Pub. No.: US 2017/0199309 A1
(43) Pub. Date: Jul. 13, 2017

(54) OPTICAL DEVICE AND DIFFUSION FILM

(71) Applicant: Optivision Technology Inc., Hsinchu (TW)

(72) Inventors: Kuang-Lin YUAN, Taichung City (TW); Tsung-Hsien WU, Hsinchu City (TW); Li-Jen HSU, Yilan County (TW); Ming-Cheng SHIH, Taoyuan City (TW); Pei-Heng LEE, Hsinchu City (TW); Yen-Shao LIN, Taipei City (TW); Yu-Hsin CHANG, Yunlin County (TW)

(21) Appl. No.: 15/333,875

(22) Filed: Oct. 25, 2016

(30) Foreign Application Priority Data
Jan. 12, 2016 (TW) 105100762
Jan. 12, 2016 (TW) 105200366

(51) Int. Cl. G02B 5/02; G02B 19/00; G02B 5/04

(52) U.S. Cl. CPC G02B 5/0221; G02B 5/045; G02B 5/0278; G02B 19/0004

(57) ABSTRACT

An optical device includes a diffusion film including a diffusion film and a condensing film. The diffusion film includes a diffusion layer that exhibits adhesive property and that has a light-incident surface and a light-emitting surface. The light-emitting surface is disposed oppositely of the light-incident surface and having a first microstructure. The condensing film includes a light-transmissive base layer that is adhered onto the light-emitting surface, and a prism layer provided on the light-transmissive base layer opposite to the diffusion film.

### CROSS-REFERENCE TO RELATED APPLICATION

This application claims priority of Taiwanese Patent Application No. 105100762, filed on Jan., 12, 2016, and Taiwanese Patent Application No. 105200366, filed on Jan. 12, 2016.

### FIELD

The disclosure relates to a diffusion film, more particularly to a diffusion film that exhibits adhesive property. The disclosure also relates to an optical device containing the diffusion film.

### BACKGROUND

A backlight module provides a light source having high brightness and high uniformity for a panel display. A conventional side-edge type backlight module includes a reflective housing, a light source disposed within the reflective housing, a light guide plate having a side portion that faces the light source and connected to the reflective housing, a reflective film disposed at the bottom of the light guide plate, a diffusion film, a condensing film and a light gathering film. The diffusion film, the condensing film and the upper light gathering film are sequentially arranged on the top of the light guide plate.

When the light emitted from the light source passes through the light guide plate and reaches the diffusion film, the light will be uniformly diffused by the diffusion film. Afterward, the diffused light will travel into the condensing film and the upper light gathering film so as to change the traveling direction thereof, thereby accomplishing the light gathering purpose and resulting in enhanced brightness. However, a light-incident surface of the condensing film is likely to be scratched by the diffusion film during assembly of the backlight module, thereby reducing the optical properties of the condensing film. Furthermore, with the thinning tendency of optical films, the condensing film with small thickness may have poor structural strength and is likely to be deformed by an external force, thereby resulting in poor optical performance.

### SUMMARY

Therefore, an object of the disclosure is to provide an optical device that can alleviate at least one of the drawbacks of the prior art.

According to the disclosure, the optical device includes a diffusion film and a condensing film.

The diffusion film includes a diffusion layer that exhibits adhesive property and that has a light-incident surface and a light-emitting surface. The light-emitting surface is disposed oppositely of the light-incident surface and has a first microstructure.

The condensing film includes a light-transmissive base layer that is adhered onto the light-emitting surface, and a prism layer provided on the light-transmissive base layer opposite to the diffusion film.

Another object of the disclosure is to provide a diffusion film that can alleviate at least one of the drawbacks of the prior art.

According to the disclosure, the diffusion film is adapted to be used with a condensing film of an optical device and includes a diffusion layer.

The diffusion layer exhibits adhesive property and has a light-incident surface and a light-emitting surface. The light-emitting surface is disposed oppositely of the light-incident surface and has a first microstructure.

### BRIEF DESCRIPTION OF THE DRAWINGS

Other features and advantages of the disclosure will become apparent in the following detailed description of the embodiment (s) with reference to the accompanying drawings, of which:

FIG. 1 is a schematic view illustrating a first embodiment of an optical device according to the disclosure;

FIG. 2 is a schematic view illustrating a second embodiment of an optical device according to the disclosure;

FIG. 3 is a flow chart illustrating a method of preparing a diffusion layer included in the first embodiment of the disclosure;

FIGS. 4 to 7 are schematic views showing consecutive steps of the method illustrated in FIG. 3, and

FIG. 8 is a SEM image of a first microstructure of the diffusion layer of the optical device of the disclosure;

FIG. 9 is a schematic view illustrating a backlight module including the optical device of the disclosure; and

FIG. 10 is a schematic view illustrating a light path in the optical device of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

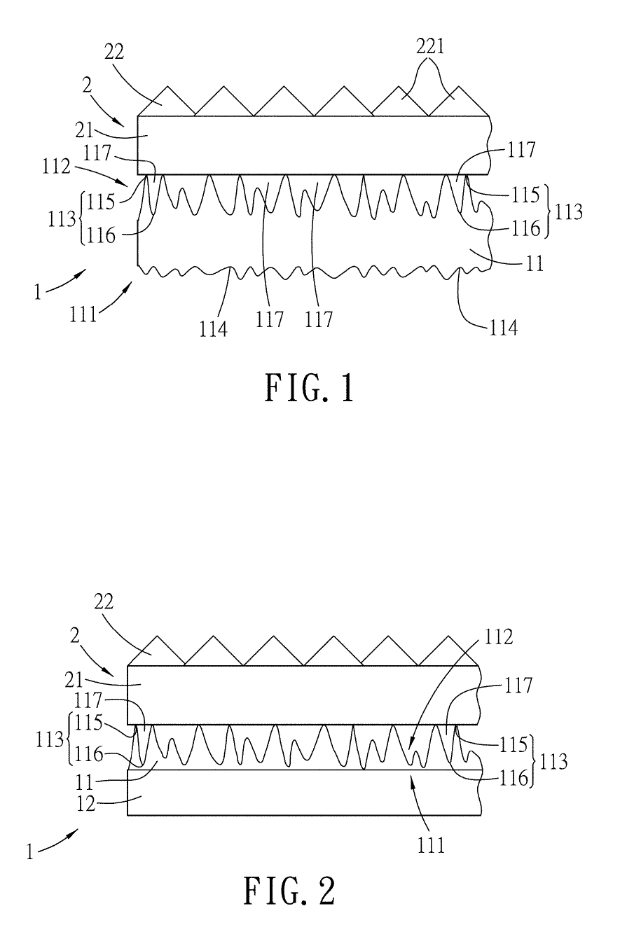

FIG. 1 illustrates the first embodiment of an optical device that includes a diffusion film 1 and a condensing film 2.

The diffusion film 1 includes a diffusion layer 11 that exhibits adhesive property and that has a light-incident surface 111 and a light-emitting surface 112. The light-emitting surface 112 is disposed oppositely of the light-incident surface 111 and has a first microstructure 113. In this embodiment, the light-incident surface 111 of the diffusion layer 11 has a second microstructure 114.

The condensing film 2 includes a light-transmissive base layer 21 that is adhered onto the light-emitting surface 112, and a prism layer 22 that includes a plurality of prisms and that is provided on the light-transmissive base layer 21 opposite to the diffusion film 1.

The first microstructure 113 of the diffusion layer 11 has a plurality of peaks 115 protruding toward the condensing film 2, and a plurality of valleys 116 indented toward the light-incident surface 111. The light-transmissive base layer 21 contacts some of the peaks 115 and does not contact the valleys 116. The peaks 115, the valleys 116 and the light-transmissive base layer 21 cooperatively define a plurality of diffusion spaces 117. The diffusion spaces 117 ensure that the traveling direction of the light that is to be emitted into the light-transmissive base layer 21 from the diffusion film 1 will be changed, so as to achieve diffusion property.

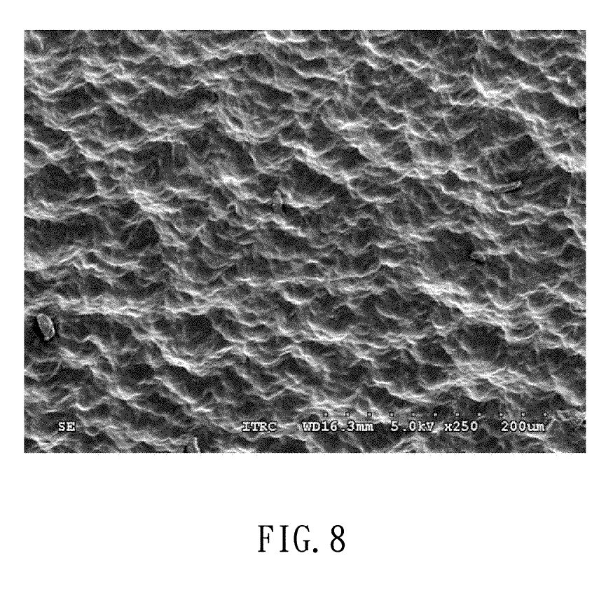

In this disclosure, since the condensing film 2 is bonded to the diffusion film 1 by virtue of the adhesive property of the diffusion film 1, the diffusion film 1 and the condensing film 2 may not move relative to each other. Therefore, the condensing film 2 will not be scratched and damaged. Moreover, since there is no need to use an adhesive for bonding the condensing film and the diffusion film 1 together, the adverse influence on the diffusion effect of the optical device caused by the adhesive can be avoided. FIG. 8 is a SEM image showing the first microstructure 113. The first microstructure 113 may have a roughness ranging from 0.5 μm to 2.0 μm. When the roughness of the first microstructure 113 is less than 0.5 μm, the diffusion spaces 117 may not be enough to accomplish the desired diffusion effect. When the roughness of the first microstructure 113 is greater than 2.0 μm, the peeling force required to remove the diffusion layer 11 from the condensing film 2 maybe decreased, and the adhesion between the diffusion layer 11 and the condensing film 2 would be reduced. In order to prevent unsatisfactory adhesion or relative movement between the diffusion layer 11 and the condensing film 2, the peeling force required to remove the diffusion layer 11 from the condensing film 2 may be designed to be greater than 200 gf/25 mm.

The second microstructure 114 is used to increase the number of reflection of the light. In certain embodiments, the second microstructure 114 has a roughness ranging from 0.3 μm to 1.5 μm. When the roughness of the second microstructure 114 is less than 0.3 μm, the diffusion layer 11 may be adsorbed onto a light guide plate in a subsequent assembly process of a backlight module, thereby adversely affecting the quality of the backlight module. When the roughness of the second microstructure 114 is greater than 1.5 μm, the light-incident efficiency of the diffusion film 1 may be undesirably affected.

In certain embodiments, the diffusion layer 11 is made from a UV curable resin.

In certain embodiments, the UV curable resin is selected from the group consisting of a UV curable pressure sensitive adhesive, a UV curable optical clear resin and the combination thereof.

In certain embodiments, the diffusion layer 11 has an index of refraction ranging from 1.4 to 1.6.

In certain embodiments, the diffusion layer 1 has an index of refraction ranging from 1.45 to 1.55.

In certain embodiments, the diffusion layer 11 has a pencil scratch hardness (according to Wolff Wilborn pencil hardness test) ranging from 2B to 2H. When the pencil scratch hardness is less than 2B, the structural strength of the diffusion layer 11 is insufficient. When the pencil scratch hardness is greater than 2H, the light guide plate maybe scratched or damaged by the diffusion film 1. In certain embodiments, the diffusion layer 11 has a pencil scratch hardness ranging from 2B to H.

In order to prevent electrostatic accumulation in the light-incident surface 111 and further adsorption of the diffusion film 1 with other optical films during assembly of a backlight module, in certain embodiments, each of the light-incident surface 111 and the light-emitting surface 112 of the diffusion film 1 has a surface electric resistance ranging from 1.0×10¹¹ ohm to 1.0×10¹⁶ ohm.

In certain embodiments, the diffusion layer 11 has a thickness ranging from 11 μm to 25 μm. When the thickness of the diffusion layer 11 is less than 11 μm, the diffusion layer 11 may be easily damaged by an external force. When the thickness of the diffusion layer 11 is greater than 25 μm, after the condensing film 2 is adhered to the diffusion layer 11, deformation may occur due to uneven stress.

In certain embodiments, the light-transmissive base layer 21 is made from a transparent flexible material. In certain embodiments, the light-transmissive base layer 21 is made from a material selected from the group consisting of polyethylene terephthalate (PET), polycarbonate (PC) and the combination thereof. It should be noted that materials that will not influence the light-incident efficiency of the diffusion film 1 and the condensing film 2 may also be used in this disclosure. In this embodiment, the light-transmissive base layer 21 is made from PET.

In certain embodiments, the light-transmissive base layer 21 further includes a diffusion structure on a surface that is in contact with the diffusion film 1 so as to improve the diffusion effect of the light.

Since the diffusion film 1 and the condensing film 2 are adhered together, the structural strength may be improved and the optical device is unlikely to be destroyed by an external force. Moreover, for protection purposes during transportation and storage, two protective films (not shown) may cover the diffusion layer 11 and the prism layer 22. The number of the protective film used in this disclosure may be reduced as compared to where the diffusion film 1 and the condensing film 2 are separately transported and stored (in which four protective films are required to cover two sides of the diffusion film 1 and two sides of the condensing film 2).

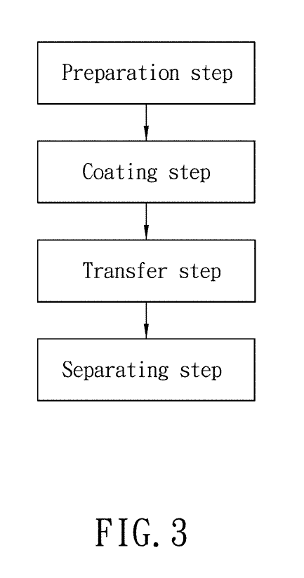

Referring to FIG. 2, a second embodiment of the optical device according to the disclosure differs from the first embodiment in that the diffusion film 1 further includes a substrate 12 attached to the light-incident surface 111 of the diffusion layer 11. In this embodiment, the second microstructure 114 is omitted.

It should be noted that the light-transmissive base layer 21 may be formed with a diffusion structure on a surface that is in contact with the diffusion film 1 so as to improve the diffusion effect of the light. Similarly, the substrate 12 may be formed with a diffusion structure on a light-incident surface that is disposed oppositely of the light-incident surface 111 of the diffusion layer 11.

In certain embodiments, the substrate 12 is made from a material selected from the group consisting of PET, PC and the combination thereof.

Similarly, in this embodiment, only two protecting films may be required to cover the substrate 12 and the prism layer 22.

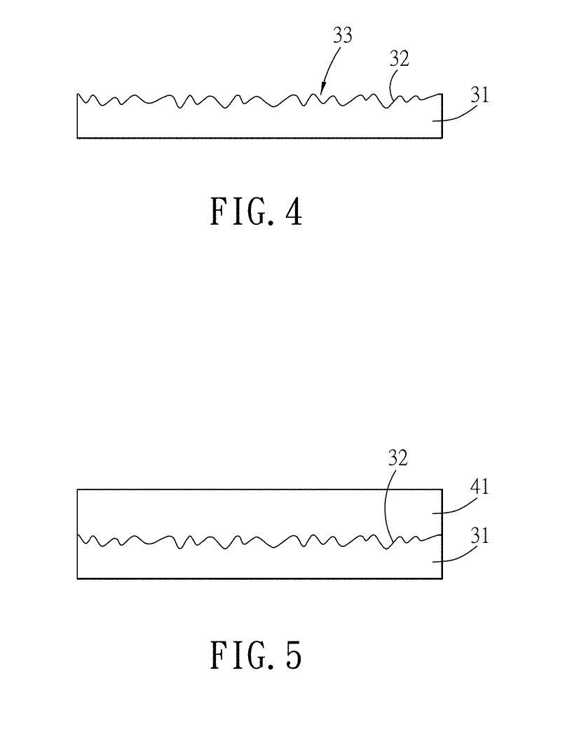

Referring to FIGS. 3 to 7, a method of preparing the diffusion film 1 of the optical device of the disclosure is shown to include the steps as follows.

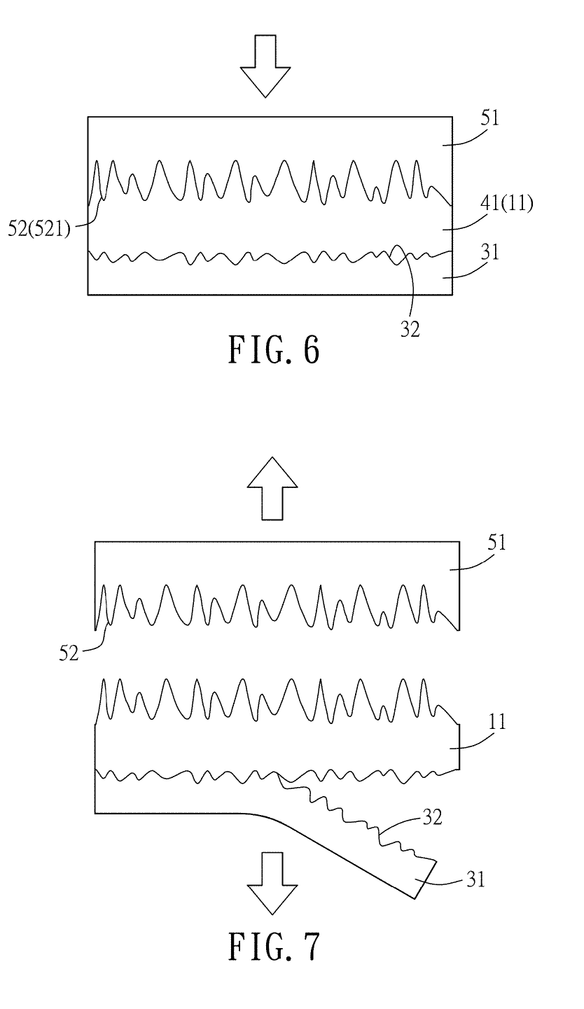

Preparation Step (S1): providing a supporting layer 31 (see FIG. 4). The supporting layer 31 has a coating surface 32, and the coating surface 32 has a third microstructure 33 that is complementary to the second microstructure 114. In certain embodiments, the third microstructure 33 has a roughness ranging from 0.3 μm to 1.5 μm.

Coating Step (S2): coating a UV curable resin 41 that exhibits adhesive property on the coating surface 32 of the supporting layer 31, so that a surface of the UV curable resin 41 that attaches to the coating surface 32 is formed with the second microstructure 114 (see FIG. 5).

Transfer step (S3): providing a mold 51 that is made from a metal material and that has a transfer surface 52. The transfer surface 52 has a fourth microstructure 521 which is complementary to the first microstructure 113. In certain embodiments, the fourth microstructure 521 has a roughness ranging from 0.5 μm to 2.0 μm. The mold 51 is pressed to contact the UV curable resin 41 so as to transfer a pattern complementary to the fourth microstructure 521 onto the UV curable resin 41, followed by curing the UV curable resin 41 with a UV light source (not shown) (see FIG. 6) , thereby obtaining the diffusion layer 11 formed with the first microstructure 113.

Separating step (S4): separating the mold 51 and the substrate 12 from the diffusion layer 11 (see FIG. 7) . After peeling the supporting layer 31 from the light-incident surface 111 of the diffusion layer 11, the surface no longer has adhesive property, and will not stick with another element in the subsequent assembly process of the backlight module. In certain embodiments, the supporting layer 31 may not be removed, and is used as the substrate 12 of the second embodiment or the aforesaid protective film for protection of the diffusion layer 11. It should be noted that, after separating the metal mold 51 from the diffusion layer 11, the light emitting surface 112 of the diffusion layer 11 still has adhesive property to a non-metal material.

The condensing film 2 is then bonded to the light emitting surface 112 of the diffusion layer 11 by virtue of the adhesive property of the light emitting surface 112.

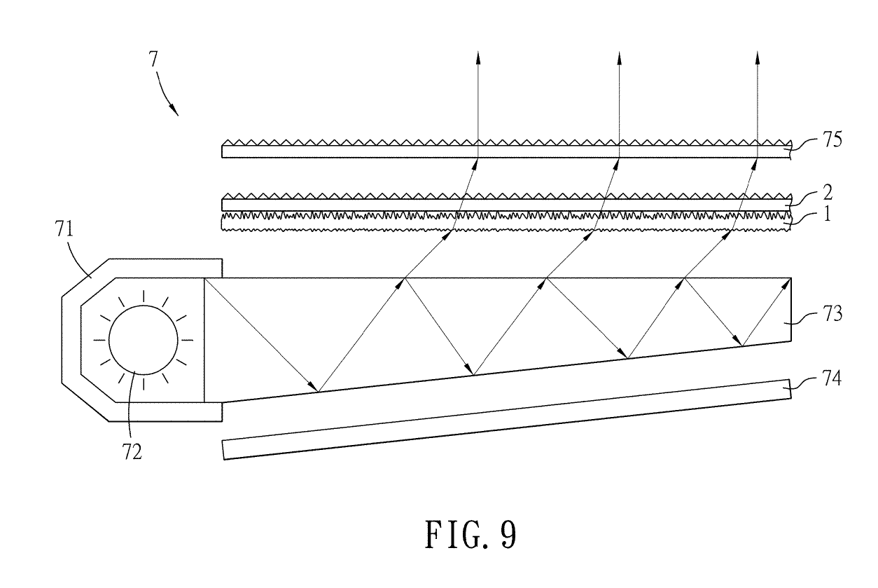

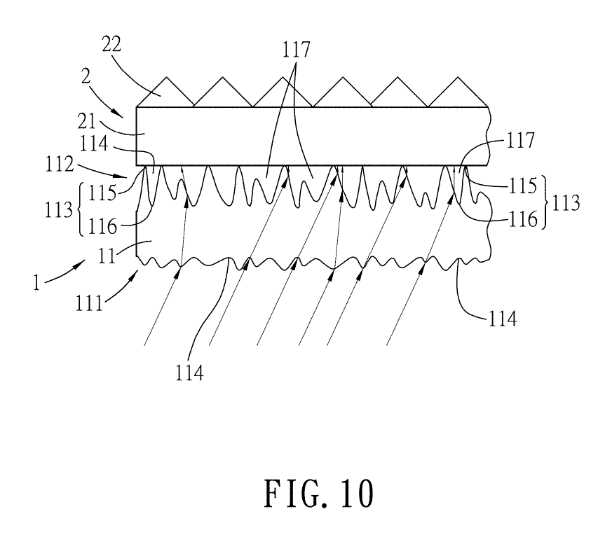

FIG. 9 illustrates a side-edge type backlight module 7 that includes the optical device of the disclosure. The side-edge type backlight module 7 includes a reflective housing 71, a light source 72 disposed within the reflective housing 71, a light guide plate 73 having a side portion that faces the light source and connected to the reflective housing 71, a reflective film 74 disposed at the bottom of the light guide plate 73, the diffusion film 1, the condensing film 2 and alight gathering film 75. The diffusion film 1, the condensing film 2 and the light gathering film 75 are sequentially arranged on the top of the light guide plate 73. Referring to FIGS. 9 and 10, light generated by the light source 72 is directed into the light guide plate 73, and then enters the diffusion film 1 through the second microstructure 114 at which the light is diffused. Afterward, the light is directed into the diffusion space 117 defined by the first microstructure and the condensing film 2 and is further diffused. The light then passes through the condensing film 2 and the light gathering film 75 to modify the traveling direction of the light in order to enhance brightness.

In conclusion, with the inclusion of the diffusion layer 11 that exhibits adhesive property, the diffusion film 1 and the condensing film 2 can be adhered with each other without relative movement. As such, the aforementioned problems of the prior art can be alleviated.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An optical device, comprising:
a diffusion film including a diffusion layer that exhibits adhesive property and that has a light-incident surface and a light-emitting surface, said light-emitting surface being disposed oppositely of said light-incident surface and having a first microstructure; and
a condensing film including a light-transmissive base layer that is adhered onto said light-emitting surface, and a prism layer provided on said light-transmissive base layer opposite to said diffusion film.

2. The optical device of claim 1, wherein said light-incident surface of said diffusion layer having a second microstructure.

3. The optical device of claim 1, wherein said diffusion film further includes a substrate attached to said light-incident surface of said diffusion layer.

4. The optical device of claim 1, wherein said first microstructure of said diffusion layer has a plurality of peaks protruding toward said condensing film, and a plurality of valleys indented toward said light-incident surface, said light-transmissive base layer contacting some of said peaks and not contacting said valleys, said peaks, said valleys and said light-transmissive base layer cooperatively defining a plurality of diffusion spaces.

5. The optical device of claim 1, wherein said diffusion layer is made from an UV curable resin.

6. The optical device of claim 5, wherein said UV curable resin is selected from the group consisting of an UV curable pressure sensitive adhesive, an UV curable optical clear resin and the combination thereof.

7. The optical device of claim 2, wherein said first microstructure has a roughness ranging from 0.5 μm to 2.0 μm, and said second microstructure has a roughness ranging from 0.3 μm to 1.5 μm.

8. The optical device of claim 1, wherein said diffusion layer has an index of refraction ranging from 1.4 to 1.6.

9. The optical device of claim 8, wherein said diffusion layer has an index of refraction ranging from 1.45 to 1.55.

10. The optical device of claim 1, wherein said diffusion layer has a pencil scratch hardness ranging from 2B to 2H.

11. The optical device of claim 1, wherein each of said light-incident surface and said light-emitting surface of said diffusion layer has a surface electric resistance ranging from 1.0×10¹¹ ohm to 1.0×10¹⁶ ohm.

12. The optical device of claim 1, wherein said diffusion layer has a thickness ranging from 11 μm to 25 μm.

13. The optical device of claim 1, wherein the peeling force required to remove said diffusion layer from said condensing film is greater than 200 gf/25 mm.

14. The optical device of claim 1, wherein said light-transmissive base layer is made from a material selected from the group consisting of polyethylene terephthalate, polycarbonate and the combination thereof.

15. The optical device of claim 3, wherein said substrate is made from a material selected from the group consisting of polyethylene terephthalate, polycarbonate and the combination thereof.

16. A diffusion film adapted to be use with a condensing film of an optical device, comprising:
a diffusion layer that exhibits adhesive property and that has a light-incident surface and a light-emitting surface, said light-emitting surface being disposed oppositely of said light-incident surface and having a first microstructure.

17. The diffusion film of claim 16, wherein said light-incident surface of said diffusion layer further having a second microstructure.

18. The diffusion film of claim 16, wherein said first microstructure of said diffusion layer has a plurality of peaks protruding toward said condensing film, and a plurality of valleys indented toward said light-incident surface, said condensing film being adapted to contact some of said peaks and not contact said valleys.

19. The diffusion film of claim 16, wherein said first microstructure has a roughness ranging from 0.5 μm to 2.0 μm, and said second microstructure has a roughness ranging from 0.3 μm to 1.5 μm.

20. diffusion film of claim 15, wherein said diffusion layer is made from an UV curable resin.
